(19) United States
(12) Patent Application Publication
(10) Pub. No.: US 2010/0062357 A1
(43) Pub. Date: Mar. 11, 2010

(54) Pigment Preparation Based on Diketopyrrolopyrroles

(75) Inventors: Matthias Ganschow, Wiesbaden (DE); Jens Reichwagen, Wiesbaden (DE); Tanja Reipen, Mainz (DE); Jens Paetzold, Buerstadt (DE)

Correspondence Address: CLARIANT CORPORATION;INTELLECTUAL PROPERTY DEPARTMENT, 4000 MONROE ROAD, CHARLOTTE, NC, 28205, US

(73) Assignee: CLARIANT FINANCE (BVI) LIMITED, Tortola (VG)

(21) Appl. No.: 12/530,112

(22) PCT Filed: Feb. 20, 2008
(86) PCT No.: PCT/EP2008/001307

§ 371 Date: Sep. 8, 2009

(30) Foreign Application Priority Data
Mar. 7, 2007 (DE) 102007011067.9
Feb. 20, 2008 (EP) PCT/EP2008/001307

(51) Int. Cl. C08K 5/3415; C09D 11/00; C09D 11/02; G03G 9/09; F21V 9/00

(52) U.S. Cl. 430/108.21; 106/498; 106/31.78; 524/92; 252/582

(57) ABSTRACT

The invention relates to a pigment preparation based on C.I. Pigment Red 254 content with an average particle size of between 20 and 100 nm, and to at least one pigment dispersant of formula (II).

The present invention relates to new pigment preparations comprising C.I. Pigment Red 254 as base pigment and certain pigment dispersants which are anionic or contain amine groups, and are based on C.I. Pigment Red 255.

Pigment preparations are combinations of base pigments and what are called pigment dispersants, which are pigments substituted by groups having specific activity. The pigment dispersants are added to the pigments in order to facilitate their dispersion in the application media, in particular in paints and inks, including printing inks, and to enhance the rheological and coloristic properties of the pigments. By this means it is possible to achieve an increase in, for example, the color strength, the transparency, and the gloss in numerous applications.

Color filters are produced using particularly finely divided pigments in order largely to rule out particle scattering, which leads to a reduction in the contrast ratio.

WO 01/04215 discloses a finely divided diketopyrrolopyrrole pigment, C.I. Pigment Red 254 (I),

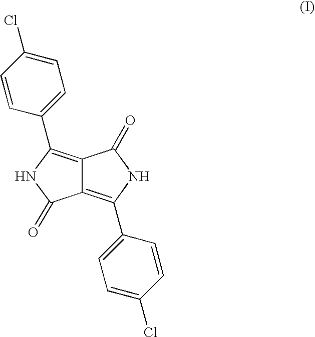

which is characterized by a particularly narrow particle size distribution in conjunction with high crystallinity and specific absorption characteristics. A C.I. Pigment Red 254 of this kind can be obtained by first stirring a crude pigment with an inorganic salt under dry conditions at least 80° C. and then subjecting the product to a kneading operation with inorganic salts in the presence of organic solvents.

On the basis of these known processes, commercial products are available and are recommended for applications in which there is a need for high transparency, such as in color filters. These pigments, however, do not always satisfy all of the requirements of the art. In particular there has been a need for improvement in terms of transparency, dispersibility, and rheology.

EP-A1-1 104 789, EP-B1-1 362 081 and JP 03026767 describe pigment dispersants based on pigments, such as on diketopyrrolopyrroles or quinacridones, for example.

The object was to provide pigment preparations comprising C.I. Pigment Red 254 as base pigment that exhibit high color strength, low viscosity, and extremely low deviation in shade from the C.I. Pigment Red 254 base pigment, and that are suitable in particular for color filter applications.

It has been found that pigment preparations based on C.I. Pigment Red 254 having a defined particle size, and on the pigment dispersants defined below, achieve this object, although on the basis of the coloristics of the individual compounds a much greater deviation in shade would have been expected.

The invention provides pigment preparations comprising C.I. Pigment Red 254 having an average particle size d₅₀ of 20 to 100 nm and at least one pigment dispersant of the formula (II)

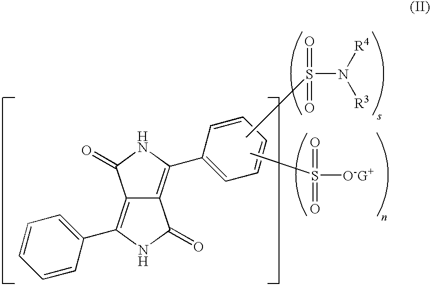

in which
s is a number from 1 to 5, preferably 1 to 3;
n is a number from 0 to 4, preferably 0 to 2, the sum of s and n being 1 to 5;
R³ is a branched or unbranched, saturated or unsaturated, aliphatic hydrocarbon radical having 1 to 20 carbon atoms, or is a C₅-C₇ cycloalkyl radical, or is an araliphatic or aromatic radical having 1, 2 or 3 aromatic rings, it being possible for the rings to be fused or to be linked by a bond, or is a heterocyclic radical having 1, 2 or 3 rings containing 1, 2, 3 or 4 heteroatoms from the group O, N, and S, or a combination thereof; the stated hydrocarbon, cycloalkyl, aromatic, araliphatic, and heteroaromatic radicals may be substituted by 1, 2, 3 or 4 substituents from the group of OH, CN, F, Cl, Br, NO₂, CF₃, C₁-C₆ alkoxy, S—C₁-C₆ alkyl, NHCONH₂, NHC(NH)NH₂, NHCO—C₁-C₆ alkyl, C₁-C₆ alkyl, COOR⁵, COO⁻E⁺, CONR⁵R⁶, NR⁵R⁶, SO₃R⁵, SO₃⁻E⁺ or SO₂—NR⁵R⁶, with R⁵ and R⁶ being alike or different and being hydrogen, phenyl or C₁-C₆ alkyl;
R⁴ is hydrogen or R³;
E⁺, G⁺ independently of one another are H⁺ or the equivalent M^{p+}/m of a metal cation M^{p+} from main group 1 to 5 or from transition group 1 or 2 or 4 to 8 of the Periodic Table of the Elements, m being one of the numbers 1, 2 or 3 and p being the number 1, 2 or 3; or is a substituted or unsubstituted ammonium ion.

In preferred pigment dispersants of the formula (II)
R³ is C₁-C₆ alkyl, benzyl, phenyl, phenyl-NR⁵R⁶, phenyl-COO⁻E⁺, phenyl-SO₃⁻E⁺, C₁-C₆ alkyl-NR⁵R⁶, C₁-C₆ alkyl-SO₃⁻E⁺ or C₁-C₆ alkyl-COO⁻E⁺, with R⁵ and R⁶ being alike or different and being hydrogen, phenyl or C₁-C₆ alkyl;
R⁴ is hydrogen, C₁-C₆ alkyl, benzyl or phenyl,
E⁺, G⁺ independently of one another are hydrogen, an alkaline earth metal, an alkali metal or a metal from main group three, more particularly Li, Na, K, Ca, Sr, Ba or Al.

Where E⁺ and/or G⁺ are an ammonium ion the following are suitable:

(i) NR⁷R⁸R⁹R¹⁰, the substituents R⁷, R⁸, R⁹, and R¹⁰ independently of one another being a hydrogen atom, C₁-C₃₀ alkyl, C₂-C₃₀ alkenyl, C₅-C₃₀ cycloalkyl, phenyl, (C₁-C₈) alkyl-phenyl, (C₁-C₄) alkylene-phenyl, or a (poly)alkyleneoxy group of the formula —[CH(R¹¹)—CH(R¹¹)—O]ₖ—H, in which k is a number from 1 to 30 and the two radicals R¹¹ independently of one another are hydrogen, C₁-C₄ alkyl or, if k is >1, a combination thereof;
and in which alkyl, alkenyl, cycloalkyl, phenyl or alkylphenyl identified as R⁷, R⁸, R⁹ and/or R¹⁰ may be substituted by amino, hydroxyl, and/or carboxyl;
or where the substituents R⁷ and R⁸ together with the quaternary N atom may form a five-membered to seven-membered saturated ring system, which if desired also contains further heteroatoms from the group of O, S, and N;
or where the substituents R⁷, R⁸, and R⁹ together with the quaternary N atom may form a five-membered to seven-membered aromatic ring system, which if desired also contains further heteroatoms from the group of O, S, and N, and to which, if desired, additional rings are fused on; or
(ii) an ammonium ion of the formula (III),

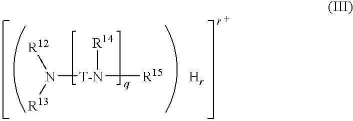

in which
R¹², R¹³, R¹⁴, and R¹⁵ independently of one another are hydrogen or a
   (poly)alkyleneoxy group of the formula —[CH(R¹¹)—CH(R¹¹)O]ₖ—H, in which k and R¹¹ are as defined above;
q is a number from 1 to 10;
r is a number from 1 to 5, where r≦q+1;
T is a branched or unbranched C₂-C₆ alkylene radical; or in which T, if q is >1, can also be a combination of branched or unbranched C₂-C₆ alkylene radicals.

The pigment dispersants of the formula (II) are compounds known per se and can be prepared by known processes, in accordance for example with JP 03026767 or

### EP-B1-1 362 081.

In the pigment preparations of the invention the weight ratio of C.I. Pigment Red 254 to the pigment dispersant of the formula (II) is preferably between (99.9:0.1) and (80:20), more preferably between (99:1) and (83:17), in particular between (98:2) and (85:15), and with very particular preference between (96:4) and (88:12).

For a mixture of the components C. I. Pigment Red 254 and the pigment dispersant of the invention in the claimed proportion, a deviation of ΔH and ΔC of in each case greater than 3.0 would be expected. Chroma (C) is the parameter describing the chromaticity of the color for a given lightness; ΔC describes the difference in the chromaticity of two colors. Similarly, ΔH describes the difference in hue for two colors under comparison.

Surprisingly, however, it has been found that a coloration in accordance with DIN EN ISO 787-26 with ⅓ standard depth of color in the alkyd/melamine resin varnish system with a pigment preparation of the invention, in comparison to a coloration with pure C.I. PR 254 and identical particle size, exhibits a ΔH (according to CIELAB) of preferably not more than 2.0, in particular not more than 1.5, and more preferably not more than 1.0. Preferably the ΔC (according to CIELAB) is not greater than 2.0, in particular not greater than 1.5, and more preferably not greater than 1.0.

The pigment preparations of the invention are preferably of high crystallinity, characterized by a main-peak width at half peak height of 0.2 to 0.7°2theta, in particular of 0.3 to 0.5°2theta, in the X-ray powder diffractogram with CuKₐₗₚₕₐ radiation.

The pigment preparations of the invention comprise the base pigment with an average particle size d₅₀ of 20 to 100 nm, preferably 30 to 80 nm, more particularly 30 to 60 nm. The particle size distribution of C.I. Pigment Red 254 is preferably approximate to a Gaussian distribution, in which the standard deviation sigma is preferably less than 40 nm, more preferably less than 30 nm. In general, the standard deviations are between 5 and 40 nm, preferably between 10 and 30 nm.

The pigment preparations of the invention surprisingly have a very low viscosity, preferably a viscosity of 3 to 50 mPa·s, measured at 20° C. using a cone-and-plate viscometer, an example being the RS75 from Haake.

Besides the diketopyrrolopyrrole pigment and the pigment dispersant, the pigment preparations of the invention may comprise further, customary auxiliaries or additives, such as, for example, surfactants, dispersants, fillers, standardizers, resins, waxes, defoamers, antidust agents, extenders, antistats, preservatives, drying retardants, wetting agents, antioxidants, UV absorbers, and light stabilizers, preferably in an amount of 0.1% to 10% by weight, in particular 0.5% to 5% by weight, based on the total weight of the pigment preparation.

Suitable surfactants include anionic, or anion-active, cationic, or cation-active, and nonionic or amphoteric substances, or mixtures of these agents.

Examples of suitable anionic substances include fatty acid taurides, fatty acid N-methyltaurides, fatty acid isethionates, alkylphenylsulfonates, an example being dodecylbenzenesulfonic acid, alkylnaphthalenesulfonates, alkylphenol polyglycol ether sulfates, fatty alcohol polyglycol ether sulfates, fatty acid amide polyglycol ether sulfates, alkylsulfosuccinamates, alkenylsuccinic monoesters, fatty alcohol polyglycol ether sulfosuccinates, alkanesulfonates, fatty acid glutamates, alkylsulfosuccinates, fatty acid sarcosides; fatty acids, examples being palmitic, stearic and oleic acid; the salts of these anionic substances and soaps, examples being alkali metal salts of fatty acids, naphthenic acids and resin acids, abietic acid for example, alkali-soluble resins, rosin-modified maleate resins for example, and condensation products based on cyanuric chloride, taurine, N,N′-diethylaminopropylamine and p-phenylenediamine. Preference is given to resin soaps, i.e., alkali metal salts of resin acids.

Examples of suitable cationic substances include quaternary ammonium salts, fatty amine oxalkylates, polyoxyalkyleneamines, oxalkylated polyamines, fatty amine polyglycol ethers, primary, secondary or tertiary amines, examples being alkylamines, cycloalkylamines or cyclized alkylamines, especially fatty amines, diamines and polyamines derived from fatty amines or fatty alcohols, and the oxalkylates of said amines, imidazolines derived from fatty acids, polyaminoamido or polyamino compounds or resins having an amine index of between 100 and 800 mg of KOH per g of the polyaminoamido or polyamino compound, and salts of these cationic substances, such as acetates or chlorides, for example.

Examples of suitable nonionic and amphoteric substances include fatty amine carboxyglycinates, amine oxides, fatty alcohol polyglycol ethers, fatty acid polyglycol esters, betaines, such as fatty acid amide N-propyl betaines, phosphoric esters of aliphatic and aromatic alcohols, fatty alcohols or fatty alcohol polyglycol ethers, fatty acid amide ethoxylates, fatty alcohol-alkylene oxide adducts, and alkylphenyl polyglycol ethers.

By nonpigmentary dispersants are meant substances which structurally are not derived from organic pigments. They are added as dispersants either during the actual preparation of pigments, but often, also, during the incorporation of the pigments into the application media that are to be colored: for example, during the production of color filters, by dispersing the pigments into the corresponding binders. They may be polymeric substances, examples being polyolefins, polyesters, polyethers, polyamides, polyimines, polyacrylates, polyisocyanates, block copolymers thereof, copolymers of the corresponding monomers, or polymers of one class modified with a few monomers from a different class. These polymeric substances carry polar anchor groups such as, for example, hydroxyl, amino, imino and ammonium groups, carboxylic acid and carboxylate groups, sulfonic acid and sulfonate groups or phosphonic acid and phosphonate groups, and may also have been modified with aromatic, nonpigmentary substances. Nonpigmentary dispersants may additionally also be aromatic substances modified chemically with functional groups and not derived from organic pigments. Nonpigmentary dispersants of this kind are known to the skilled worker and in some cases are available commercially (e.g., Solsperse®, Avecia; Disperbyk®, Byk-Chemie; Efka®, Efka). A number of types will be named below, by way of representation, although in principle any desired other substances described can be employed, examples being condensation products of isocyanates and alcohols, diols or polyols, amino alcohols or diamines or polyamines, polymers of hydroxycarboxylic acids, copolymers of olefin monomers or vinyl monomers and ethylenically unsaturated carboxylic acids and carboxylic esters, urethane-containing polymers of ethylenically unsaturated monomers, urethane-modified polyesters, condensation products based on cyanuric halides, polymers containing nitroxyl compounds, polyester amides, modified polyamides, modified acrylic polymers, dispersants with a comblike structure comprising polyesters and acrylic polymers, phosphoric esters, triazine-derived polymers, modified polyethers, or dispersants derived from aromatic, nonpigmentary substances. These parent structures are in many cases modified further, by means for example of chemical reaction with further substances carrying functional groups, or by means of salt formation.

The pigment preparation of the invention can be employed as a preferably aqueous presscake or as moist granules, but generally comprises solid systems of pulverulent nature.

The invention also provides a process for preparing a pigment preparation of the invention, which comprises admixing C. I. Pigment Red 254 with the pigment dispersant of the formula (II) before or during an operation of fine division, such as kneading, wet grinding or dry grinding, or immediately before or during a finish treatment.

For example, the dry components in granule or powder form can be mixed before or after any grinding; one component can be added to the other component in moist or dry form, as for example by mixing the components in the form of the moist presscakes.

Mixing can be accomplished, for example, by grinding in dry form, in moist form, by kneading for example, or in suspension, or by a combination of these methods. Grinding may be carried out with the addition of water, solvents, acids or grinding assistants such as salt. A kneading operation leading to the fine division of the pigment crystals is more particularly an operation of salt kneading in the presence of an organic solvent.

Mixing can also be accomplished by adding the pigment dispersant during the operation of preparing the C. I. Pigment Red 254.

The pigment dispersant is added to the C. I. Pigment Red 254, though, preferably after the C. I. Pigment Red 254 has been formed chemically, and before or during the formation of the fine particles.

With particular preference the pigment dispersant is added to the diketopyrrolopyrrole pigment during an operation of dry or wet grinding. The finely crystalline pigment preparation formed in the course of grinding can be subjected to an aftertreatment, generally referred to as a finish, in water and/or solvents, for example, and generally at elevated temperature, up to 200° C. for example, and, if desired, elevated pressure. The pigment dispersant can also be added after dry or wet grinding but before or during finishing. The pigment dispersant can of course also be added in portions at different times.

The drying of a moist pigment preparation may be carried out using the known drying assemblies, such as drying ovens, bucket-wheel dryers, tumble dryers, contact dryers, and, in particular, spin flash dryers and spray dryers.

The invention also provides a pigment preparation obtainable by the above-described process.

The pigment preparations of the invention are notable for their outstanding coloristic and rheological properties, in particular high flocculation stability, ready dispersibility, good rheology, high color strength, transparency, and saturation (chroma). In numerous application media they are dispersible readily with up to high levels of fineness. Pigment dispersions of this kind exhibit outstanding rheological properties even when the paint or printing-ink concentrates are highly pigmented. Other properties as well, such as gloss, fastness to overcoating, solvent fastness, alkali and acid fastness, light and weather fastnesses, and high purity of hue, are very good. Moreover, the pigment preparations of the invention can be used to obtain hues in the red range which are in demand for use in color filters. In that application they provide high contrast and also satisfy the other requirements posed in the context of use in color filters, such as high temperature stability or steep and narrow absorption bands. They can be prepared with high purity and low ion content.

The pigment preparations of the invention can be employed in principle for pigmenting all high molecular mass organic materials of natural or synthetic origin, such as plastics, resins, varnishes, more particularly metallic varnishes, paints, electrophotographic toners and developers, electret materials, color filters, and inks, including printing inks, for example.

High molecular mass organic materials which can be pigmented with the pigment preparations of the invention are, for example, cellulose compounds, such as, for example, cellulose ethers and cellulose esters, such as ethylcellulose, nitrocellulose, cellulose acetates or cellulose butyrates, natural binders, such as, for example, fatty acids, fatty oils, resins and their conversion products or synthetic resins, such as polycondensates, polyadducts, addition polymers and copolymers, such as, for example, amino resins, especially urea and melamine formaldehyde resins, alkyd resins, acrylic resins, phenoplasts and phenolic resins, such as novolaks or resols, urea resins, polyvinyls, such as polyvinyl alcohols, polyvinyl acetals, polyvinyl acetates or polyvinyl ethers, polycarbonates, polyolefins, such as polystyrene, polyvinyl chloride, polyethylene or polypropylene, poly(meth)acrylates and copolymers thereof, such as polyacrylic esters or polyacrylonitriles, polyamides, polyesters, polyurethanes, coumarone-indene and hydrocarbon resins, epoxy resins, unsaturated synthetic resins (polyesters, acrylates) with the different cure mechanisms, waxes, aldehyde and ketone resins, gum, rubber and its derivatives and latices, casein, silicones and silicone resins; individually or in mixtures.

It is unimportant whether the aforementioned high molecular mass organic compounds are present in the form of plastic masses or melts or in the form of spinning solutions, dispersions, varnishes, paints or printing inks. Depending on the intended use it proves advantageous to utilize the pigment preparations of the invention in the form of a blend or in the form of prepared products or dispersions.

It is also possible only to prepare the pigment preparation at the time of incorporation into the high molecular mass organic medium.

The present invention consequently further provides a high molecular mass organic material comprising a coloristically effective amount of a pigment preparation of the invention.

Based on the high molecular mass organic material it is intended to pigment, the pigment preparation of the invention is employed usually in an amount of 0.01% to 30% by weight, preferably 0.1% to 20% by weight. For color filter applications, higher colorant concentrations may also be employed.

The pigment preparations of the invention are also suitable for use as colorants in electrophotographic toners and developers, such as, for example, one- or two-component powder toners (also called one- or two-component developers), magnetic toners, liquid toners, polymerization toners, and specialty toners.

Typical toner binders are addition-polymerization resins, polyaddition resins and polycondensation resins, such as styrene, styrene-acrylate, styrene-butadiene, acrylate, polyester, phenolic-epoxy resins, polysulfones, polyurethanes, individually or in combination, and also polyethylene and polypropylene, which may also include further ingredients, such as charge control agents, waxes or flow assistants, or may be modified subsequently with these added ingredients.

The pigment preparations of the invention are additionally suitable for use as colorants in powders and powder coating materials, particularly in triboelectrically or electrokinetically sprayable powder coating materials which are employed to coat the surfaces of articles made, for example, from metal, wood, plastic, glass, ceramic, concrete, textile material, paper or rubber.

Moreover the pigment preparations of the invention are suitable for use as colorants in ink-jet inks on both an aqueous and a nonaqueous basis, and also in inks which operate in accordance with the hot-melt process. Ink-jet inks generally contain a total of 0.5% to 15% by weight, preferably 1.5% to 8% by weight (reckoned on a dry basis), of the pigment preparation of the invention.

Microemulsion inks are based on organic solvents, water, and, where appropriate, an additional hydrotropic substance (interface mediator). Microemulsion inks contain generally 0.5% to 15% by weight, preferably 1.5% to 8% by weight, of the pigment preparation of the invention, 5% to 99% by weight of water, and 0.5% to 94.5% by weight of organic solvent and/or hydrotropic compound.

“Solvent-based” ink-jet inks contain preferably 0.5% to 15% by weight of the pigment preparation of the invention, 85% to 99.5% by weight of organic solvent and/or hydrotropic compounds.

Hot-melt inks are based usually on waxes, fatty acids, fatty alcohols or sulfonamides which are solid at room temperature and liquefy on heating, the preferred melting range being between about 60° C. and about 140° C. Hot-melt ink-jet inks are composed, for example, essentially of 20% to 90% by weight of wax and 1% to 10% by weight of the pigment preparation of the invention. They may further include 0 to 20% by weight of an additional polymer (as “dye dissolver”), 0 to 5% by weight of dispersing assistant, 0 to 20% by weight of viscosity modifier, 0 to 20% by weight of plasticizer, 0 to 10% by weight of tack additive, 0 to 10% by weight of transparency stabilizer (which prevents, for example, crystallization of the waxes), and 0 to 2% by weight of antioxidant.

Particularly the pigment preparations of the invention are also suitable for use as colorants for color filters, both for additive and for subtractive color generation, such as, for example, in electrooptical systems such as television screens, LCDs (liquid crystal displays), charge-coupled devices, plasma displays or electroluminescent displays, which may in turn be active (twisted nematic) or passive (supertwisted nematic) ferroelectric displays or light-emitting diodes, and also as colorants for electronic inks (or e-inks) or electronic paper (e-paper).

In the production of color filters, both reflective and transparent color filters, pigments are applied in the form of a paste or as pigmented photoresists in suitable binders (acrylates, acrylic esters, polyimides, polyvinyl alcohols, epoxides, polyesters, melamines, gelatins, caseins) to the respective LCD components (e.g., TFT-LCD=Thin Film Transistor Liquid Crystal Displays or, e.g., (S) TN-LCD=(Super) Twisted Nematic-LCD). Besides high thermal stability, high pigment purity is a prerequisite for a stable paste and/or a pigmented photoresist. Furthermore, the pigmented color filters can also be applied by ink-jet printing processes or other suitable printing processes.

The red hues of the pigment preparations of the invention are especially suitable for the red-green-blue (R, G, B) color filter colorset. These three colors are present as separate color dots alongside one another, and when backlit produce a full-color image. Typical colorants for the red color dot are pyrrolopyrrole, quinacridone and azo pigments, such as C. I. Pigment Red 254, C. I. Pigment Red 209, C. I. Pigment Red 175, and C. I. Pigment Orange 38, for example, individually or mixed. For the green color dot, phthalocyanine colorants are typically employed, such as C. I. Pigment Green 36 and C. I. Pigment Green 7, for example.

As and when required, the respective color dots may also be admixed with further colors for the purpose of shading. For the red and green hue it is preferred to carry out blending with yellow, as for example with C. I. Pigment Yellow 138, 139, 150, 151, 180, and 213.

In the examples which follow, parts and percentages are by weight unless indicated otherwise.

### EXAMPLE 1

### Bead Milling of C. I. Pigment Red 254 in the Presence 10% of the Pigment Dispersant

A mixture of 70 parts of P.R. 254, 1.4 parts of a commercial flow improver based on naphthalenesulfonic acid, 800 parts of zirconium oxide beads (0.4-0.6 mm), 600 parts of water and 7 parts of a pigment dispersant of the formula (IV),

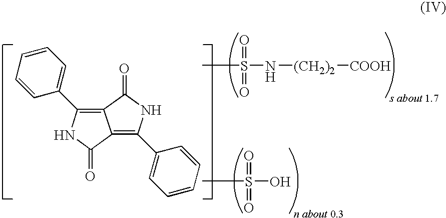

prepared in the same way as in EP 1362081, is ground in a Drais® Advantis V3 mill. The duration of grinding corresponds to five to six theoretical grinding passes. The millbase is separated from the beats and filtered, and the filtercake is heated at reflux for 2 hours with a 1:1 mixture of water and isobutanol at a pH of 2. Following steam distillation, the mixture is filtered and the solid product is washed salt-free with water, dried under reduced pressure and, finally, pulverized. This gives a red pigment preparation having an average particle size d₅₀ of 35 nm (TEM).

### EXAMPLE 2

### Bead Milling of C.I. Pigment Red 254 and addition of 10% of the pigment dispersant prior to solvent treatment

A mixture of 90 parts of P.R. 254, 1.8 parts of a commercial flow improver based on naphthalenesulfonic acid and 800 parts of water is formed into a homogeneous paste and ground using a Drais® Advantis V3 mill in the presence of 800 parts of zirconium oxide beads (0.4-0.6 mm). The duration of grinding corresponds to five to six theoretical grinding passes. 740 parts of the approximately 10% grinding suspension are admixed with 7.4 parts of a pigment dispersant (IV) and isobutanol, thus giving a 1:1 mixture of isobutanol and water. The suspension is heated at reflux for 2 hours at a pH of 2; after the isobutanol has been separated off by steam distillation, the solid product is washed salt-free with water, dried under reduced pressure and, finally, pulverized. This gives a red pigment preparation having an average particle size d₅₀ of 41 nm (TEM).

### EXAMPLE 3

### Bead Milling of C.I. Pigment Red 254 in the Presence of 5% of the Pigment Dispersant

A procedure the same as in example 1 is followed, but using only 3.5 parts, rather than 7 parts, of a pigment dispersant of the formula (IV). This gives a red pigment preparation having an average particle size d₅₀ of 37 nm (TEM).

### EXAMPLE 4

### Bead Milling of C.I. Pigment Red 254 and Addition of 5% of the Pigment Dispersant Prior to a Solvent Treatment

A procedure the same as in example 2 is followed, but using only 3.7 parts, rather than 7.4 parts, of a pigment dispersant of the formula (IV). This gives a red pigment preparation having an average particle size d₅₀ of 39 nm (TEM).

### EXAMPLE 5

### Bead Milling of C.I. Pigment Red 254 in the Presence of 10% of the Pigment Dispersant

A procedure the same as that of example 1 is followed, but using a pigment dispersant of the formula (V) prepared in the same way as in EP 1362081.

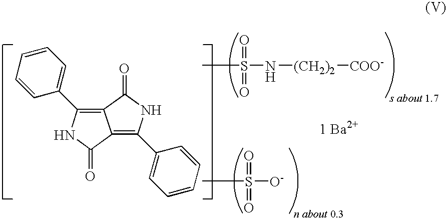

This gives a red pigment preparation having an average particle size d₅₀ of 62 nm (TEM).

### EXAMPLE 6

### Bead Milling of C.I. Pigment Red 254 and Addition of 10% of the Pigment Dispersant Prior to a Solvent Treatment

A procedure the same as that of example 2 is followed, but using a pigment dispersant of the formula (V).

This gives a red pigment preparation having an average particle size d₅₀ of 46 nm (TEM).

### EXAMPLE 7

### Bead Milling of C.I. Pigment Red 254 in the Presence of 5% of the Pigment Dispersant

A procedure the same as in example 5 is followed, but using only 3.5 parts, rather than 7 parts, of a pigment dispersant of the formula (V). This gives a red pigment preparation having an average particle size d₅₀ of 48 nm (TEM).

### EXAMPLE 8

### Bead Milling of C.I. Pigment Red 254 and Addition of 5% of the Pigment Dispersant Prior to a Solvent Treatment

A procedure the same as in example 6 is followed, but using only 3.7 parts, rather than 7.4 parts, of a pigment dispersant of the formula (V). This gives a red pigment preparation having an average particle size d₅₀ of 59 nm (TEM).

### EXAMPLE 9

### Bead Milling of C.I. Pigment Red 254 in the Presence of 10% of the Pigment Dispersant

A procedure the same as that of example 1 is followed, but using a pigment dispersant of the formula (VI) prepared in the same way as in JP 03026767.

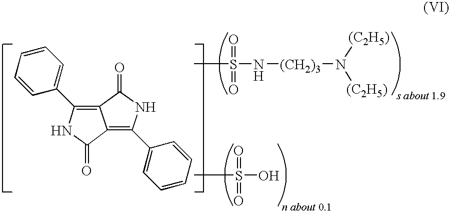

This gives a red pigment preparation having an average particle size d₅₀ of 49 nm (TEM).

### EXAMPLE 10

### Bead Milling of C.I. Pigment Red 254 and Addition of 10% of the Pigment Dispersant Prior to a Solvent Treatment

A procedure the same as that of example 2 is followed, but using a pigment dispersant of the formula (VI). This gives a red pigment preparation having an average particle size d₅₀ of 60 nm (TEM).

### EXAMPLE 11

### Bead Milling of C.I. Pigment Red 254 in the Presence of 5% of the Pigment Dispersant

A procedure the same as in example 9 is followed, but using only 3.5 parts, rather than 7 parts, of a pigment dispersant of the formula (VI). This gives a red pigment preparation having an average particle size d₅₀ of 51 nm (TEM).

### EXAMPLE 12

### Bead Milling of C.I. Pigment Red 254 and Addition of 5% of the Pigment Dispersant Prior to a Solvent Treatment

A procedure the same as in example 10 is followed, but using only 3.7 parts, rather than 7.4 parts, of a pigment dispersant of the formula (VI). This gives a red pigment preparation having an average particle size d₅₀ of 56 nm (TEM).

### EXAMPLE 13

### Salt Kneading of C.I. Pigment Red 254 in the Presence of 10% of the Pigment Dispersant

A mixture of 15 parts of P.R. 254, 1.5 parts of a pigment dispersant (VI), 90 parts of microcrystalline sodium chloride and 26 parts of diethylene glycol are kneaded on a double-trough kneader at 80° C. for 24 hours. The kneading compound is stirred in 900 parts of hydrochloric acid at 90° C. for two hours and the solid is isolated by filtration, washed to neutrality with water, and dried. This gives a red pigment preparation having an average particle size d₅₀ of 45 nm (TEM).

### EXAMPLE 14

### Salt Kneading of C.I. Pigment Red 254 in the Presence of 5% of the Pigment Dispersant

A procedure the same as in example 13 is followed, but using only 0.75 part, rather than 1.5 parts, of a pigment dispersant of the formula (VI). This gives a red pigment preparation having an average particle size d₅₀ of 49 nm (TEM).

### COMPARATIVE EXAMPLE A

### Bead milling of C.I. Pigment Red 254 without a Pigment Dispersant

A mixture of 90 parts of P.R. 254, 1.8 parts of a commercial flow improver based on naphthalenesulfonic acid and 800 parts of water is formed into a homogeneous paste and ground using a Drais® Advantis V3 mill in the presence of 800 parts of zirconium oxide beads (0.4-0.6 mm). The duration of grinding corresponds to five to six theoretical grinding passes. The duration of grinding corresponds to five to six theoretical grinding passes. The grinding suspension is admixed with isobutanol, thus giving a 1:1 mixture of isobutanol and water. The suspension is heated at reflux for 2 hours at a pH of 2; after the isobutanol has been separated off by steam distillation, the solid product is washed salt-free with water, dried under reduced pressure and, finally, pulverized. This gives a red pigment preparation having an average particle size d₅₀ of 102 nm (TEM).

### Particle Size Distribution of the Samples:

For the particle size distribution a series of electron micrographs is used. The primary particles are identified visually. The area of each primary particle is determined by means of a graphics tablet. From the area, the diameter of the circle of equal area is determined. The frequency distribution of the equivalent diameters thus calculated is determined, and the frequencies are converted to volume fractions and expressed as particle size distribution.

The standard deviation is a measure of the breadth of the distribution. The smaller the standard deviation, the narrower the particle size distribution.

TABLE 1
Particle size distribution and standard deviation

| | | Standard deviation σ |
|---|---|---|
| Sample | d₅₀ [nm] | [nm] |
| Example 1 | 35 | 11 |
| Example 2 | 41 | 15 |
| Example 3 | 37 | 13 |
| Example 4 | 39 | 11 |
| Example 5 | 62 | 21 |
| Example 6 | 46 | 16 |
| Example 7 | 48 | 25 |
| Example 8 | 59 | 23 |
| Example 9 | 49 | 14 |
| Example 10 | 60 | 17 |
| Example 11 | 51 | 26 |
| Example 12 | 56 | 19 |
| Example 13 | 45 | 12 |
| Example 14 | 49 | 14 |
| Comparative example A | 102 | 42 |

### Crystallinity of the Samples:

The magnitude of the value at half peak height of the reflections in the X-ray powder diffractogram is a measure of the crystallinity of the samples. The lower the value at half peak height, the more crystalline the material under analysis. By value at half peak height is meant the width of the reflection at half peak height (half of the maximum) of the largest peak in each case (at 28°).

The value at half peak height for the samples is measured using a STOE/Θ diffractometer (Cu—K_{α}, U=40 kV, I=40 mA) (slits: primary side/vertical 2×8 mm, primary side/horizontal 1.0 mm, secondary side 0.5 mm). The sample holder used is a standard steel holder. The measuring time is adapted to the desired statistical reliability, the angular range 2θ in the overview measurement is 5-30°, and the step width is 0.02° with a time period of 3 s. In the specialty range, measurement is carried out from 23-30° with a step width of 0.02° and a time period of 6 s.

The X-ray beam is monochromated by a graphite secondary monochromator and subjected to measurement with a scintillation counter, with continuous sample rotation. For the purpose of evaluation, a profile fit is carried out over the entire angular range of the second measurement 2θ=23-30° (fit function: Lorentz² (4 reflections)).

TABLE 2
Crystallinity

| | Value at half peak height [°2θ] |
|---|---|
| Sample | (main peak) |
| Example 1 | 0.36 |
| Example 2 | 0.42 |
| Example 3 | 0.41 |
| Example 4 | 0.39 |
| Example 5 | 0.44 |
| Example 6 | 0.42 |
| Example 7 | 0.48 |
| Example 8 | 0.45 |
| Example 9 | 0.43 |
| Example 10 | 0.38 |
| Example 11 | 0.41 |
| Example 12 | 0.44 |
| Example 13 | 0.53 |
| Example 14 | 0.58 |

Viscosity of a millbase for color filter applications: 10 g of pigment or pigment preparation from the above-described examples are suspended in 73 g of PGMEA (propylene glycol monomethyl ether acetate), admixed with 17 g of a commercially customary, high molecular mass block copolymer and 250 g of zirconium oxide beads (0.3 mm), and dispersed for three hours in the Paintshaker Disperse DAS 200 from Lau GmbH.

The millbase viscosity is determined using a Haake RS75 cone-and-plate viscometer at 20° C.

TABLE 3
Viscosity

| Sample | Viscosity [mPa · s] |
|---|---|
| Example 1 | 7 |
| Example 2 | 6 |
| Example 3 | 18 |
| Example 4 | 16 |
| Example 5 | 56 |
| Example 6 | 65 |
| Example 7 | 52 |
| Example 8 | 61 |
| Example 9 | 20 |
| Example 10 | 42 |
| Example 11 | 29 |
| Example 12 | 38 |
| Example 13 | 15 |
| Example 14 | 12 |
| Comparative example A | 96 |

The pigment preparations described are applied using a spincoater (POLOS Wafer Spinner) to glass plates (SCHOTT, laser-cut, 10×10 cm). Because of the low viscosities, bright, highly transparent, red colorations are obtained with a low film thickness (500 to 1300 nm) and very good contrast (TSUBOSAKA ELECTRIC CO., LTD, Model CT-1), which differ only a little from the hue of the samples without additives.

The pigment preparations from examples 1 to 14 are highly suitable for color filter applications on account of their high contrast.

Application examples for transparent baking varnishes: For the determination of the color strength, the chroma ΔC, and the hue ΔH of the pigment mixtures, the pigment preparations obtained were dispersed completely in a transparent alkyd-melamine baking varnish system, to give a masstone varnish. Subsequently a white reduction varnish was prepared, by mixing 6 parts of the alkyd-melamine masstone varnish with 20 parts of a 30% white varnish.

The resulting white reduction varnish was drawn down alongside the white reduction varnish of the sample for comparison onto a piece of white card, and, after drying in air for 30 minutes, was baked at 140° C. for 30 minutes. The color strength and its measurement is defined according to DIN EN ISO 787-26.

The color strengths, chroma (color purity), and hue of the pigment preparations prepared in the examples above are reported in the table below.

The standard used for the color strength (100%), the chroma ΔC (color purity) (ΔC=0), and the hue ΔH (ΔH=0) was the pigment from comparative example A.

TABLE 4
Coloristics

| | Color | | |
|---|---|---|---|
| Sample | strength | ΔC | ΔH |
| Example 1 | 116% | −0.82 | 0.11 |
| Example 2 | 108% | −1.35 | −0.98 |
| Example 3 | 114% | −0.55 | −0.02 |
| Example 4 | 106% | −0.80 | −0.20 |
| Example 5 | 97% | −0.86 | −1.89 |
| Example 6 | 102% | −1.8 | −3.31 |
| Example 7 | 100% | −0.68 | −1.68 |
| Example 8 | 97% | −0.90 | −1.50 |
| Example 9 | 100% | −1.48 | −1.39 |
| Example 10 | 94% | −1.59 | −2.32 |
| Example 11 | 102% | −1.10 | −1.20 |
| Example 12 | 98% | −0.98 | −1.43 |
| Example 13 | 109% | −1.05 | 1.12 |
| Example 14 | 105% | −0.56 | 0.67 |
| Comparative example A | 100% | 0.0 | 0.0 |

For a mixture of the C. I. Pigment Red 254 and the pigment dispersant of the invention as components in the proportions described, a deviation of ΔH and ΔC of in each case greater than 2.0 to 3.0 would have been expected.

1) A pigment preparation comprising C.I. Pigment Red 254 having an average particle size d₅₀ of 20 to 100 nm and at least one pigment dispersant of the formula (II) 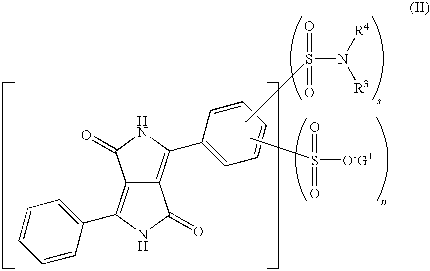
wherein
s is a number from 1 to 5;
n is a number from 0 to 4; the sum of s and n being 1 to 5;
R³ is phenyl-NR⁵R⁶, phenyl-COO⁻E⁺, phenyl-SO₃⁻E⁺, C₁-C₆ alkyl-NR⁵R⁶, C₁-C₆ alkyl-SO₃⁻E⁺ or C₁-C₆ alkyl-COO⁻E⁺, with R⁵ and R⁶ being the same or different and are hydrogen, phenyl or C₁-C₆ alkyl;
R⁴ is hydrogen, C₁-C₆ alkyl, benzyl or phenyl,
E⁺, G⁺ independently of one another are hydrogen, an alkaline earth metal, an alkali metal or a metal from main group three.

2) The pigment preparation as claimed in claim 1, wherein in the compound of the formula (II) s is a number from 1 to 3 and n is a number from 0 to 2.

3) The pigment preparation as claimed in claim 1, wherein the weight ratio of C.I. Pigment Red 254 to the pigment dispersant of the formula (II) is between (99.9:0.1) and (80:20).

4) The pigment preparation as claimed in claim 3, wherein the weight ratio of C.I. Pigment Red 254 to the pigment dispersant of the formula (II) is between (96:4) and (88:12).

5) The pigment preparation as claimed in claim 1, having a main-peak width at half peak height of 0.2 to 0.7°2theta in the X-ray powder diffractogram with CuKₐₗₚₕₐ radiation.

6) A process for preparing a pigment preparation as claimed in claim 1 comprising the steps of admixing C.I. Pigment Red 254 with the pigment dispersant of the formula (II) before or during an operation of fine division or finishing treatment.

7) A high molecular mass organic material of natural or synthetic origin pigmented by a pigment dispersion as claimed in claim 1.

8) A composition pigmented by a pigment preparation as claimed in claim 1, wherein the composition is in the form of plastics, resins, varnishes, paints, electrophotographic toners, electrophotographic developers, inks, or printing inks.

9) A composition as claimed in claim 1 pigmented by a pigment preparation as claimed in claim 1, wherein the composition is in the form of metallic varnishes, color filters, or ink-jet inks.
